(19) United States
(12) Patent Application Publication
(10) Pub. No.: US 2016/0192216 A1
(43) Pub. Date: Jun. 30, 2016

(54) ADAPTIVE PREDICTION AND REAL TIME MONITORING OF BEACONS

(71) Applicant: EBAY INC., San Jose, CA (US)

(72) Inventor: Satish Govindarajan, Los Altos, CA (US)

(21) Appl. No.: 14/586,871

(22) Filed: Dec. 30, 2014

(51) Int. Cl. H04W 24/04; G06Q 10/06

(52) U.S. Cl. CPC H04W 24/04; G06Q 10/0635

(57) ABSTRACT

A system and/or method may be provided to enable a server to monitor a plurality of wireless beacons that are deployed by a merchant in a location, such as a merchant store, a car dealership, a vehicle, a hotel, a casino, a theme park, etc. More specifically, provided are methods to enable a server to estimate a remaining lifetime for each of the monitored wireless beacons, and based on the estimated remaining lifetime, to predict a business effect assuming a failure of each of the monitored wireless beacons. Such predicted business effect may be communicated between the merchant and the server so as to let the merchant be aware of any business effect that may occur in a short-term future.

### TECHNICAL FIELD

The present invention generally relates to monitoring of a wireless beacon that is deployed by a merchant in a location and more specifically to predicting a business effect that a failure of the wireless beacon may cause.

### BACKGROUND

Various merchants at retail/merchant stores may utilize a wireless beacon or a wireless beacon network with a consumer and/or consumer device. These wireless beacons may be set up at merchant stores and communicate with the consumer device to alert the consumer of check-in services, discounts at the merchant, and/or available merchandise from the merchant. Typically, such a wireless beacon has a limited lifetime. That is, once a lifetime of a wireless beacon ends (i.e., becomes inactive, faulty, and/or out of service), a business effect may be caused to a merchant, and more particularly a series of business effects may be caused with an unawareness of the merchant about the inactive beacon. Thus, there is a need for a system or a method that provides a merchant with a comprehensive monitoring on the merchant's wireless beacons.

### BRIEF DESCRIPTION OF THE DRAWINGS

FIG. 1 is a flowchart showing a process a user performs to set up a beacon monitoring (BM) account with a service provider, according to an embodiment;

FIG. 2 is a flowchart showing a process showing a service provider performs in processing use information of a wireless beacon, according to an embodiment;

FIG. 3 is block diagram illustrating an example of a status of a wireless beacon shown on a display device, according to an embodiment;

FIG. 4 is a block diagram of a networked system suitable for implementing the process described herein, according to an embodiment; and

FIG. 5 is a block diagram of a computer system suitable for implementing one or more components in FIG. 4, according to an embodiment;

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

As defined herein, a wireless beacon is a short range communication device having a known or fixed location that provides a signal that can be detected by mobile devices within a certain proximity of the beacon. An example of a wireless beacon is a radio frequency (RF) beacon (e.g., Bluetooth™ low energy (BLE) beacon), infrared beacon or a radio frequency identifier (RFID) tag. For example, a BLE beacon can broadcast an RF signal that includes its position coordinates (e.g., latitude, longitude), which can be detected by a mobile device. In some implementations, the wireless beacon can also advertise location based services provided by a wireless beacon network. A wireless beacon network encompasses a plurality of wireless beacons in a geographic region.

Various merchants at retail/merchant stores may utilize a wireless beacon or a wireless beacon network with a consumer and/or consumer device. These wireless beacons may be set up at merchant stores and communicate with the consumer device to alert the consumer of check-in services, discounts at the merchant, and/or available merchandise from the merchant. The consumer may be notified as soon as they are in proximity to the wireless beacon through their consumer device. The wireless beacons may also be utilized to communicate information from the consumer device to the merchant and/or merchant server. More specifically, the check-in services may be completed over a network connection between a consumer device and a device/server for the merchant, or using short range wireless beacons connected to the device/server and in communication with the consumer device using short range wireless communication, such as Bluetooth Low Energy (BLE).

Generally, such wireless beacons are always operating (i.e., being turned ON) or operating during regular store hours of a merchant store. In some embodiments, the wireless beacons may be subjected to a limited lifetime. Any number of factors, in addition to a limited capacity of battery as mentioned above, may contribute to such a limited lifetime of a wireless beacon, such as, a malfunctioning, an improper operation, a heavy loading, and/or a severe operating environment of the wireless beacon. As such, the limited lifetime of the wireless beacon may in turn cause the wireless beacon to become inactive and stop communicating with consumer(s). Moreover, the inactivity of the wireless beacons and/or a merchant's ignorance on such inactivity may cause the merchant to encounter an adverse business effect or result, such as change (decrease) of revenue for the merchant, change (decrease) in numbers of customers who shop with the merchant, etc.

Alternatively or additionally, in an example, some wireless beacons that are battery-powered may be operated between a low and a high power state. That is, the wireless beacon may only ramp up in power and establish a connection to a user device after the user device has been identified by the beacon. For example, a vehicle, such as a bus, a subway, a train, a boat, a cruise ship, an airplane, and/or a limousine may use this wireless beacon to communicate with a user device using Bluetooth Low Energy (BLE), LTE Direct, or other communication protocol. Despite of not being turned ON all the time, such beacons may also be subjected to issues of power usage and/or low battery power.

In this regard, according to an embodiment, a system and/or method may provide a server to monitor a wireless beacon that is deployed by a merchant in a location, such as a merchant store, a car dealership, a vehicle, a hotel, a casino, a theme park, etc. More specifically, provided are methods to enable a server to estimate a remaining lifetime of a monitored wireless beacon, and based on the estimated remaining lifetime, to predict a business effect assuming a failure of the monitored wireless beacon. Such a predicted business effect may be communicated between the merchant and the server so as to let the merchant be aware of any business effect that may occur in a short-term future due to a specific beacon failure and to then take appropriate actions as desired, such as replacing the beacon, moving a less valuable beacon to the location of the beacon about to fail, etc.

In accordance with a further embodiment, a merchant may deploy a plurality of wireless beacons (i.e., a wireless beacon network) in a merchant store to perform communications between consumer(s) and the merchant. Through the plurality of wireless beacons, the merchant may be able to better recognize the consumer(s), and thus may advantageously benefit from using a wireless beacon. For example, communication through a wireless beacon enables a consumer to make a financial transaction with a merchant, to check-in at a merchant store, to be offered an alternative deal/product/service with a more reasonable price and/or an incentive, etc. Such convenience may consequently entice consumer(s) to shop with a merchant and/or in a merchant store. However, a wireless beacon may be subjected to a limited lifetime, wherein a lifetime may change with the wireless beacon's use information. As mentioned above, said limited lifetime of a wireless beacon may cause a merchant to lose a channel to communicate with consumer(s) and may thus encounter an adverse business effect, such as failing to update consumer(s) with new incentive(s) for purchase (especially significant to a merchant during a peak shopping season), failing to acquire consumers' information, disabling a merchant's ability to track a pattern of consumer shopping behaviors, etc. Moreover, an impact beyond a merchant's business may also be caused due to a failure of a wireless beacon. For example, in a theme park, a wireless beacon may be used to detect/determine a user's (e.g., a child) position. A failure of a wireless beacon may cause a child to enter an insecure zone, and may result in a dangerous situation. Generally, the use information of each wireless beacon may be self-monitored by itself.

According to an embodiment, by using the currently disclosed systems and/or methods, a server may be able to monitor the plurality of wireless beacons deployed in the merchant store by receiving the self-monitored use information from the wireless beacons, including various data affecting the proper operation of the beacon, such as battery power remaining, component failure, etc. Moreover, the server may use the received use information to estimate a remaining lifetime for each wireless beacon. Based on the remaining lifetime, the server may predict a business effect for each wireless beacon under an assumption that a failure (i.e., becoming inactive) of the wireless beacon occurs after the estimated remaining lifetime. In an embodiment, such business effect is predicted based on collaborating each wireless beacon within the network. That is, the predicted business effect for each wireless beacon is associatively related with other wireless beacons in the network. Thus, a merchant may be advantageously provided a more comprehensive notification to take any action to address any failure of a wireless beacon in the network.

In an embodiment, a wireless beacon is configured to self-monitor use information and communicate with the server so as to provide the monitored use information. Such communicate may include transmitting self-monitored use information from a wireless beacon to the server and receiving, by a wireless beacon, a dynamically changed period of time for the wireless beacon to perform the self-monitoring and/or the transmittal of self-monitored use information. More specifically, the dynamically changed period of time may be estimated by the server based on received use information of the wireless beacon. Being provided with such a dynamic period of time, a wireless beacon may transmit the self-monitored use information every “updated” period of time and/or record its use information every such period of time. That is, a wireless beacon may not always transmit its use information to the server, and/or may not always perform a self-monitoring. In another embodiment, the wireless beacon transmits use information when it anticipates a change in its ability to function, e.g., any anticipated change from its current condition.

In another embodiment, the disclosed system and/or method may provide a server to monitor wireless beacons and to predict business effects for more than one merchant/merchant store. As such, any merchant that has set up a beacon monitoring account with the server may be provided with a real-time monitoring on its wireless beacon(s) and may be further provided with a more comprehensive response to any failure of its wireless beacon.

When a beacon is about to fail or otherwise is about to lose some of its current capabilities, a system may be notified. The system may determine the effect failure of that beacon may have on the merchant, such as based on current traffic or communications the beacon is engaging in, historical data resulting from the beacon communication with consumer devices, sales attributable to the beacon communication with consumer devices, etc. For example if the beacon is very seldom used, such as in store location having very little foot traffic, the impact or effect of a failed beacon may be minimal. On the other hand, a beacon in a congested area where the beacon has high communication frequency (currently or in the past) with user devices regarding checkins, incentives, etc. may see a substantial negative impact (such as reduced sales, customer dissatisfaction) if the beacon fails. Depending on the projected effect, the merchant can take appropriate action, such as replacing the beacon, moving a less critical beacon to the location of the failing beacon, or simply take no action.

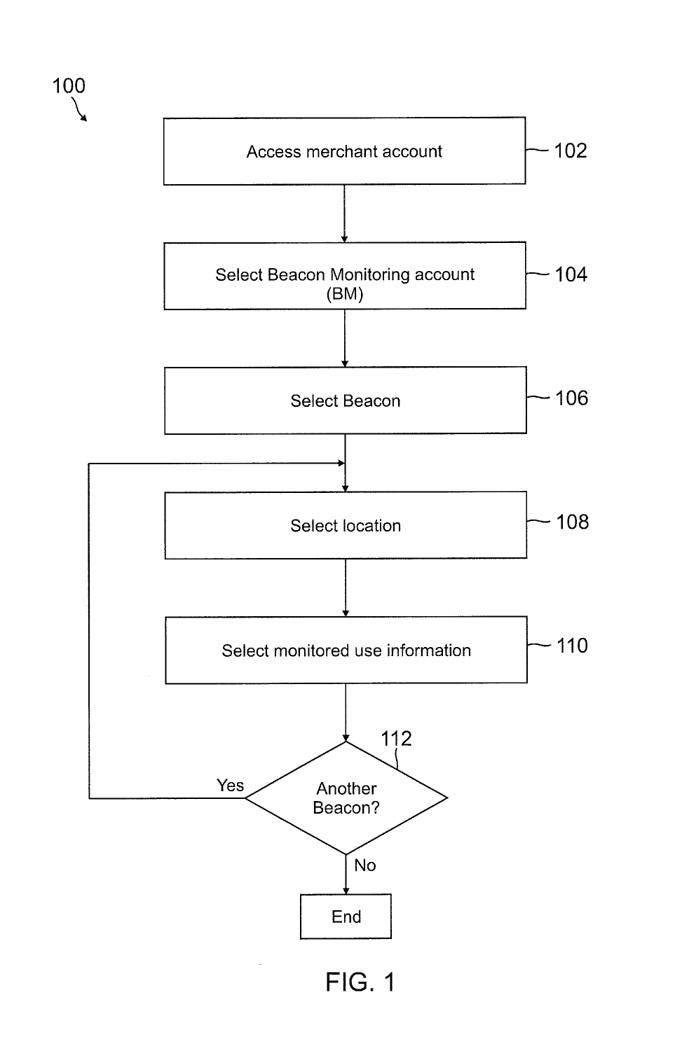

FIG. 1 is a flowchart showing a process 100 a user, or more specifically a merchant, performs to set up a beacon monitoring (BM) account with a service provider, such as PayPal Inc. of San Jose, Calif., according to one embodiment. At step 102, the merchant accesses a merchant account with the service provider. The merchant may access the account through a merchant device, such as a smart phone, a computing tablet, or other computing device. For a smart phone, the user may access a mobile app, which makes a request to the service provider and displays a login screen on the smart phone. For a computing device, the user may enter the URL address of the service provider and select a link on the service provider site that opens a login page. A merchant may wish to set up the BM account when the merchant wishes to monitor usage of wireless beacons that the merchant installs in a merchant store. As mentioned above, the wireless beacon installed in the merchant store may be used to establish a communication over a wireless network between consumer(s) and the merchant. Thus, by setting up a BM account, a merchant may not only be able to monitor a usage of a wireless beacon, but also be able to store a consumer's spending history and/or behavior. A specific BM account may not be needed in some embodiments. In those cases, as long as the merchant has an account or some relationship with the service provider, the service provider can provide services to track beacon activity, monitor beacon functionality, and provide estimates for specific beacons (in use or upon failure).

To access the user's account, the merchant may be asked to enter specific information, such as a user identifier and a login credential. These may include a user name, an email address, a phone number, a password, biometric (e.g., fingerprint scan), or a PIN. The requested information is then communicated to the service provider, such as through the merchant device or other means like a phone call or voice. If the merchant can be authenticated, the merchant is provided access to the merchant's account by the service provider.

Once the user accesses the account, the user may see a home page of the account. On the home page may be an option to create, revise, view, or otherwise access a BM account. This may be in the form of a tab, link, button, or other user-selectable means. The merchant may select this option at step 104 to access the BM account option. The merchant may then be directed to a new screen or a pop-up screen having BM account information.

Generally, a plurality of wireless beacons (e.g., a wireless beacon network) is deployed in a merchant store. Thus, at step 106, the merchant may enter or specify which of the plurality of wireless beacons to be monitored. A merchant may distinguish each wireless beacon with specific wireless beacons identifiers. Such identifiers may be named by the merchant or as part of the beacon device ID. The merchant may also select wireless beacons from a drop down menu that includes information (e.g., identifier) of the plurality of wireless beacons that the merchant plans to install in a merchant store. The merchant may be asked to confirm the selected wireless beacon or revise as needed.

At step 108, for each selected wireless beacon, the merchant may enter a location to specify where the selected wireless beacon is to be installed or is located in a merchant store. In an example, a merchant, such as Wal-Mart®, may wish to install ten wireless beacons to be uniformly distributed at aisle nine of a Wal-Mart® store. The merchant may enter the beacon location in any number of ways. For example, the user may enter an aisle name and/or corresponding information of a location in a merchant store, such as a category name. The merchant may also select desired install locations from a store map, where the user may select a specific region and be presented with a more detailed map of that region, such as a map of Men's department, then Clothing, then Jeans. Beacon location may also be automatically determined by the system, such as through location services or capabilities associated with the beacon.

At step 110, the merchant may select use information the merchant plans to monitor for the wireless beacon at the selected install location(s). For example, the merchant may select a remaining capacity of a battery power, physical or environmental conditions like ambient temperature, pressure, movements, sound, concentrations of specific elements in the air, and/or work loading. The work loading may include, but not limited to, the number user devices the wireless beacon has checked-in each day, each period, and the number of transactions the wireless beacon has processed each day. In accordance with various embodiments, the use information for each wireless beacon may be self-monitored. In some alternative embodiments, the use information for a first wireless beacon may be monitored by a second wireless beacon that is installed in proximity to the first wireless beacon. In some embodiments, the use information is automatically determined by the system, such as only types of information relevant to monitoring a possible beacon failure.

Note that one or more of the steps described herein may be combined, performed in a different sequence, omitted, and/or combined as desired. Once the merchant has finished providing information for the first wireless beacon, a determination is made at step 112 whether the merchant wishes to add another wireless beacon to be monitored. In an example, wireless beacon A is a first beacon in a wireless beacon network. So, the user may want to add the other wireless beacon to the BM account. This may be done simply with a button or link from the user account page that the user can select to add another wireless beacon. If the user is finished adding wireless beacons, the user may simply select a “finish” or other similar button or link to end the set-up process.

After entering each wireless beacon, including location and use information, the user may be presented with information about the current status of each wireless beacon. For example, the user may see a listing or a map that shows where each of the wireless beacons is located, and whether each wireless beacon is connected to the service provider.

Additionally, the merchant may access the account at any subsequent time to revise any of the information in the merchant's BM account such as a change in location, and/or a change in use information to be monitored. In one embodiment, the merchant may only change one or more details while still in the merchant store where the wireless beacons are deployed.

In another embodiment, the merchant simply installs desired beacons throughout a location to form a network, and all (or a designated subset) of beacons are monitored whenever they are active or functional. Information, such as described herein, is then provided to a system for determining when a beacon may fail in the near future. In one embodiment, the system simply monitors the beacons and determines when a specific beacon is no longer operational or fully functional. In this way, the system does not need to process data and make predictions as to when a beacon may fail.

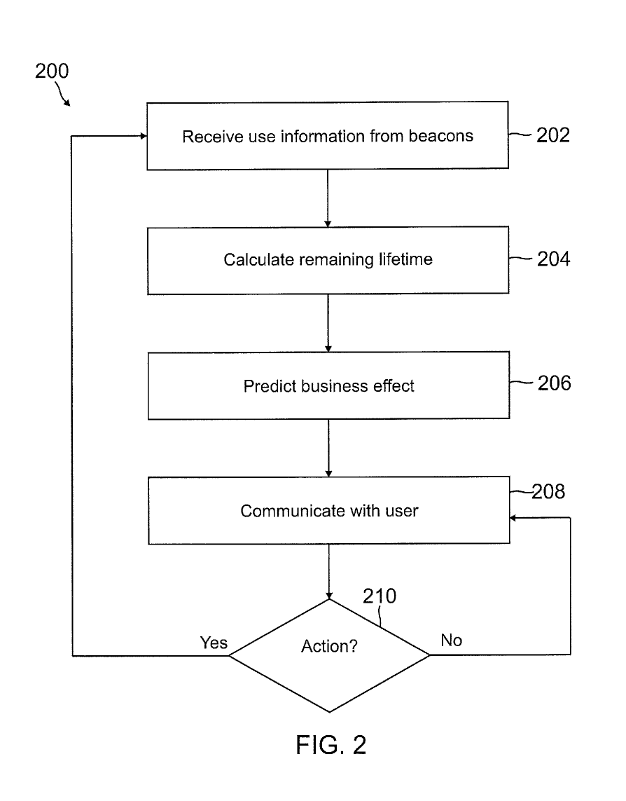

FIG. 2 is a flowchart showing a process 200 a service provider performs in predicting a business effect based on monitored use information according to one embodiment. The merchant has installed one or more wireless beacons in a merchant store, and also set up a BM account with a service provider. The process 200 starts with step 202 receiving use information for each of the wireless beacons installed in the merchant store. For example, Wal-Mart® may install one hundred wireless beacons in a Wal-Mart® store, and a BM account has been set up by Wal-Mart® to monitor ten types of use information (e.g., remaining capacity of beacon's battery power, temperature, number of transactions went through) for each wireless beacon in the store. Thus, the service provider may receive one thousand (100×10) use information during each period of time. Such a period of time may be predetermined or dynamic. In an embodiment, the service provided and/or the merchant may predetermine the period of time as a constant value, for example, 10 minutes. As such, the wireless beacon in the store may monitor its selected use information every ten minutes, and every 10 minutes, the service provider receives 1000 piece of monitored use information from the wireless beacons. In another embodiment, the service provider may dynamically change the period of time in accordance with real-time monitored use information, and communicate with the wireless beacons with the dynamically changed period of time. For example, during peak business hours (such as during sales, weekends, holiday shopping periods, etc.), the service provider may change the predetermined period of time (10 minutes) to a shorter period of time (1 minute) so as to collect more information during a same period of time. The service provider may further communicate with the wireless beacons to transmit monitored use information every 1 minute. On the other hand, during closed business hours, the service provider may increase 10 minutes to 1 hour. In some alternative embodiments, the dynamically changed period of time, provided by the service provider, may be used as an input for the wireless beacons to change the wireless beacon's operation period. Continuing with the above example, during the closed business hours, the wireless beacon may only monitor its use information every 1 hour instead of monitoring every 10 minutes or a shorter period of time like 1 second.

The use information may be transmitted over a network from the wireless beacons directly or from the wireless beacons via a network gateway, such as a merchant server that is also installed in the merchant store. In some embodiments, a merchant server generally serves as a sink device in a wireless beacon network that is configured to collect monitored use information from the wireless beacons in the network. In an alternative embodiment, in addition to monitoring the use information mentioned above, a wireless beacon may be further configured to store a consumer's interactive information (such as through the consumer's device like a smart phone, wearable computing device, a user account with a payment provider, or the like) with the wireless beacon. The interactive information may include consumer's spending history, consumer's spending behavior, etc. Such interactive information may also be transmitted over the network to the service provider.

After receiving the monitored use information from the wireless beacons, at step 204, the service provider estimates a remaining lifetime for each of the wireless beacons. In accordance with some illustrative embodiments, the estimation is based on collaboratively monitored use information. Continuing with the same example, the service provider receives ten types of use information, including remaining battery power, temperature, work loading, etc., from a wireless beacon “A”. Even though the remaining battery power for the wireless beacon A has not reach a critical low level (to cause the wireless beacon become inactive), the wireless beacon A may currently operate under a severe condition (high temperature) and with a heavy work loading. As such, after the service provider collaboratively uses the ten types of use information to estimate a remaining lifetime of the wireless beacon A, the collaboratively estimated remaining lifetime (e.g., 8 minutes) may be lower than a lifetime (e.g., 1 hr) that is according to single type of information (e.g., reaming battery power).

At step 206, based on the estimated remaining lifetime for each beacon, the service provider may predict a business effect that may be caused by a failure of each beacon. Continuing with the same example, wireless beacon A has been estimated to have 8 more minutes to operate from now. In some embodiments, the service provider may use corresponding information, including the number of consumer devices wireless beacon A has checked-in each day, and the number of transactions wireless beacon A has processed each day, and the consumer's interactive information with wireless beacon, to predict that a business effect will occur if wireless beacon A becomes inactive after 8 minutes. The business effect may include a change (e.g., decrease) of revenue for Wal-Mart® and a change (e.g., decrease) of consumer numbers who will shop using wireless beacon A. In some embodiments, at step 208, the service provider may communicate with the merchant so as to let the merchant be aware of the predicted business effect. Note that one or more of the steps described herein may be combined, performed in a different sequence, omitted, and/or combined as desired. Once the service provider has finished communicating with the merchant, a determination is made at step 210 whether the merchant wishes to take a further action such as replacing the dying wireless beacon. If an action has been made in step 210, the process 200 may route back to step 202 to receive “updated” use information from the wireless beacons. However, if no action has been made by the merchant at step 210, the process 200 may route back to step 208 to communicate with the merchant again, such as sending an alarm message and/or making a phone call to the merchant.

Since a business effect is predicted by the service provider for each beacon, a predicted business effect for one of the wireless beacons may not essentially cause a negative effect to the merchant as a whole. Thus, the disclosed systems and/or methods may advantageously provide a merchant to take an action that may be beneficial to the merchant as a whole. Continuing with the above example, the predicted business effect based on the fact that wireless beacon A becomes inactive may cause the revenues to decrease by $10,000 USD. However, due to the unavailability of wireless beacon A (decreased number of consumers shopping through wireless beacon A), an equal or larger number of consumers may opt to use wireless beacon B. As such, a business effect of the revenue increased by $15,000 USD may be predicted by the service provider for wireless beacon B. Thus, a total increase of revenue by $5,000 may be predicted from a failure of beacon A but continued operability of beacon B.

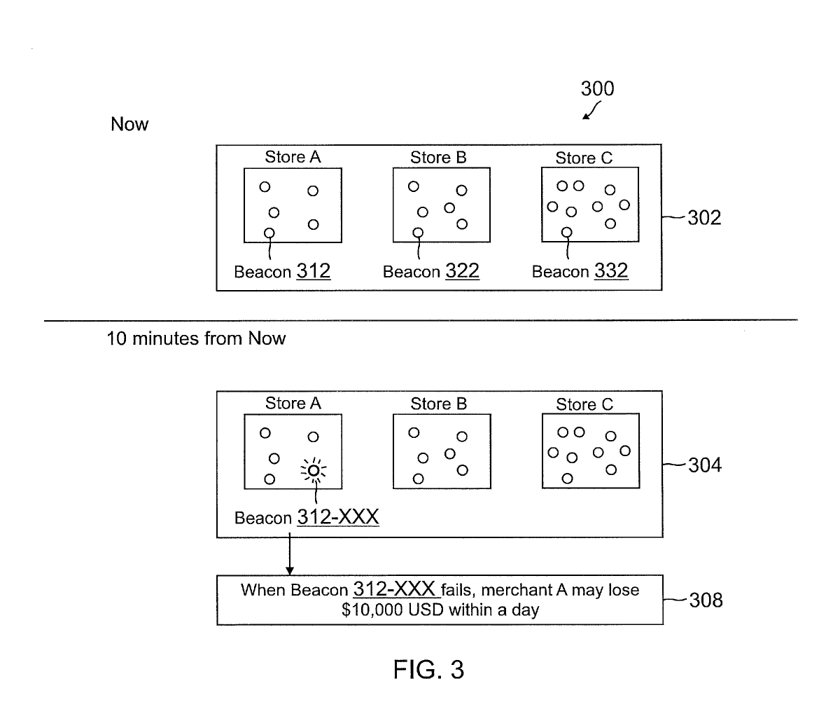

FIG. 3 is a block diagram 300 illustrating an example of a display of a merchant device that shows statuses of beacons deployed in more than one merchant stores in accordance with various embodiments. Block 302 shows a current status for each beacon deployed in stores A, B, and C; block 304 shows a predicted status (10 minutes later) for the deployed beacons in stores A, B, and C. Blocks 302 and 304 may be shown on a display device of a merchant device. More specifically, there are four beacons 312, five beacons 322, and eight beacons 332 installed respectively in stores A, B, and C. In some embodiments, each beacon shown on a display device may include additional information, such as a location of the corresponding beacon in each store. In another embodiment, block 304 may be shown as a later status (10 minutes later) that has already happened.

As noted above, the system may simply monitor beacons for failure instead of predicted failure. When a beacon fails, the system may determine the effect of failure and provide the results to the merchant. The results may also be provided on a display of a merchant device. Examples of a merchant display are shown in 302 and 304 of FIG. 3. By having additional information (beacon location) to be shown on a display device, a merchant can visually see which location has a beacon or expected beacon failure, along with effects to the merchant if the beacon is not replaced. For example, as shown in FIG. 3, block 306 shows a beacon 312-XXX may have become failed or expect to become failed. In block 308, an effect showing “When beacon 321-XXX fails, merchant A may lose $10,000 USD within a day” may be shown on a display device of merchant device A to inform merchant A. In some cases, the merchant may take no action, since the effect of a failed beacon would not impact the merchant's current business, and as such, the merchant may wait until after store hours to replace or service the beacon. In other situations, the merchant may quickly move a less critical beacon to replace the failed beacon or replace the failed beacon with a new beacon if desired (e.g., beacon available and would not impact business during the time a new beacon is found and installed). The service provider may access a database or other storage to see the effect any specific beacon has on a merchant's business, as discussed here, which can be dependent on time of day, day of week, certain events, certain times of the year (e.g., Christmas shopping) in order to provide the merchant information about the results of a failed beacon at a specific location of the store.

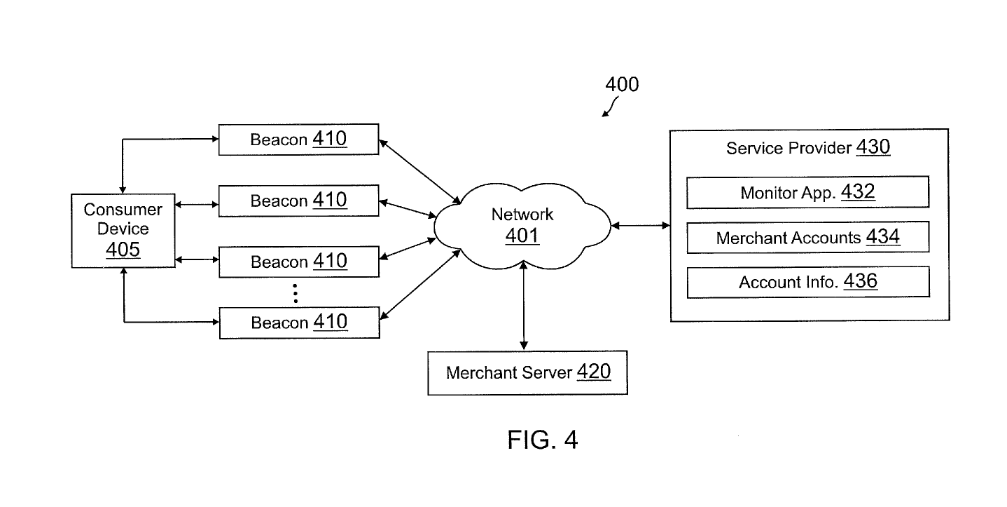

FIG. 4 illustrates an exemplary embodiment of a networked system 400 adapted for implementing a system and method for collaboratively monitoring one or more wireless beacons deployed in a merchant store. As shown, networked system 400 may comprise or implement a plurality of servers and/or software components that operate to perform various methodologies in accordance with the described embodiments. Exemplary servers may include, for example, stand-alone and enterprise-class servers operating a server operating system (OS) such as a MICROSOFT® OS, a UNIX® OS, a LINUX® OS, or other suitable server-based OS. It may be appreciated that the servers illustrated in FIG. 3 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Networked system 400 may include, among various devices, servers, databases and other elements, one or more wireless beacons 410, a merchant server 420, and a service provider 430 that communicate with each other over network 401 in accordance with various embodiments. Network 401 may be implemented as a single network or a combination of multiple networks. For example, in various embodiments, network 401 may include the Internet or one or more intranets, landline networks, wireless networks, and/or other appropriate types of networks. As shown, wireless beacons 410 may be communicatively coupled via one or more networks 401 to service provider 430 and/or merchant server 420.

Wireless beacon 410 may be maintained, for example, by a merchant corresponding to merchant server 420, such as one associated with a merchant store where wireless beacon(s) 410 may be established. Wireless beacon 410 may be implemented using any appropriate hardware and software configured for wireless communication with consumer device 405, merchant server 420, and/or service provider 430. For example, in one embodiment, wireless beacon 410 may be implemented as a dongle device including a hardware processor and a communication module, for example, connected to a device at the merchant store (e.g., merchant server 420). Wireless beacon 410 may also be implemented as a device incorporated within a personal computer (PC), a smart phone, laptop computer, and/or other types of computing devices capable of transmitting and/or receiving data, such as an IPAD® from APPLE®. Wireless beacon 410 may also act as a stand-alone device including a processor, communication module, and/or network interface component configured to communicate with consumer device 405, merchant server 420, and/or service provider 430. Although wireless beacon(s) 410 shown in FIG. 4 are directed to being deployed by a merchant and/or in a merchant store, there may be multiple pluralities of wireless beacons deployed by and/or another merchant/merchant store in such a networked system 400. For example, wireless beacons 410 may be installed in a Wal-Mart's West Los Angeles store, and there may be a second and a third pluralities of wireless beacons respectively installed in a Home Depot's East Los Angeles store and in a Staple's West Hollywood store.

In some embodiments, wireless beacon 410 may be located at a physical location corresponding to merchant server 420. The physical location may correspond to a merchant location, such as a merchant store. Wireless beacon 410 of FIG. 4 contains processes, procedures, and/or applications, for example, a software program, executable by a hardware processor configured to interact with consumer device 405, merchant server 420, and/or service provider 430. Thus, regardless of the implementation of wireless beacon 410, as discussed above, wireless beacon 410 may utilize a check-in application and a communication application to communicate with consumer device 405, merchant server 420, and/or service provider 430. In other embodiments, wireless beacon 410 may include additional or different software and devices as required. For example, wireless beacon 410 may include a self-monitoring application to self-monitor its use information as described above.

Merchant server 420 may be maintained by a merchant, and/or any other entity that deploys wireless beacon 410. Merchant server 420 may include routers, ATM machines, payment card processors, servers, and/or the like. In various implementations, merchant server 420 may be a server that may host applications associated with or employed by a merchant. The services may include, but are not limited to, check-in processing, location services, social networking, payment processing, payment verification services, and/or the like.

Service provider 430 may be maintained, for example, by an online service provider which may provide a maintenance and/or monitoring for deployed wireless beacon(s) 410. In this regard, payment provider server 430 includes one or more monitor applications 432 which may be configured to communicate with wireless beacon(s) 410 and/or merchant server 420 over network 401 to receive wireless beacon 410's use information, to perform an estimation of wireless beacon 410's remaining lifetime, to predict a business effect for beacon 410, and/or to communicate with a merchant and/or merchant server 420 as discussed above.

Service provider 430 also maintains a plurality of user/merchant accounts 434, each of which may include account information 436 associated with individual merchants/users, including beacon monitoring (BM) account information for merchants/users. For example, account information 436 may include private financial information of merchants of devices such as account numbers, passwords, device identifiers, user names, phone numbers, credit card information, bank information, information about a merchant's BM account, as discussed above.

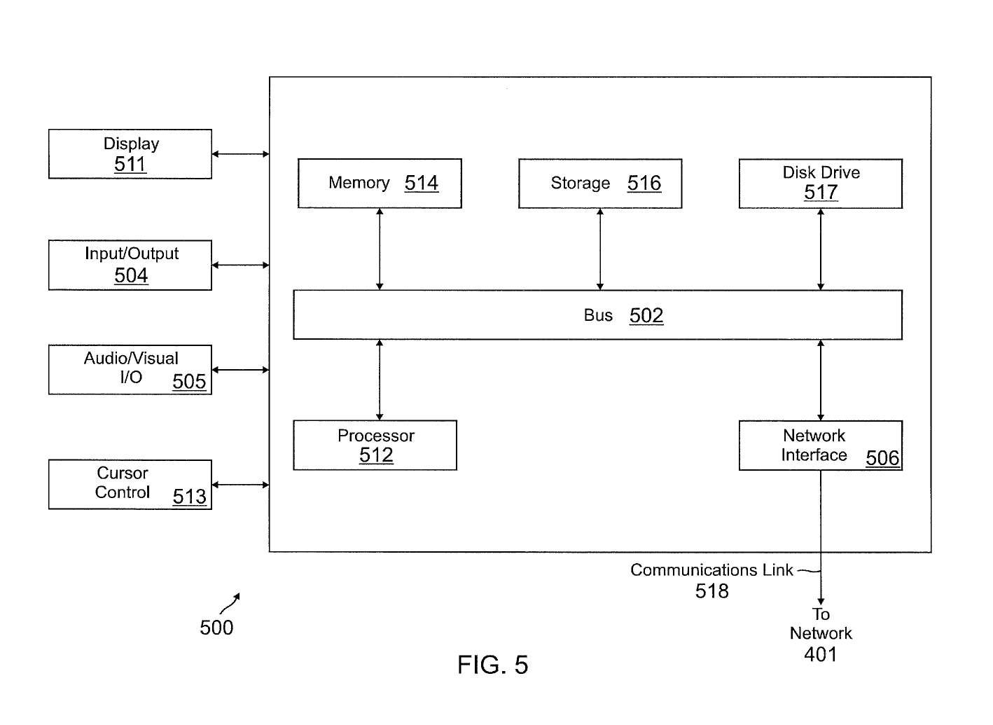

FIG. 5 is a block diagram of a computer system 500 suitable for implementing one or more embodiments of the present disclosure. In various implementations, a user device may comprise a personal computing device (e.g., smart phone, a computing tablet, a personal computer, laptop, PDA, Bluetooth device, key FOB, badge, etc.) capable of communicating with the network. The merchant and/or service provider may utilize a network computing device (e.g., a network server) capable of communicating with the network. It should be appreciated that each of the devices utilized by users, merchants, and payment providers may be implemented as computer system 400 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons or links, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a payment provider server via network 401. In one embodiment, the transmission is wireless, although other transmission mediums and methods may also be suitable. A processor 512, which can be a micro-controller, digital signal processor (DSP), or other processing component, processes these various signals, such as for display on computer system 500 or transmission to other devices via a communication link 518. Processor 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a memory device storing use information of each of a plurality of sensors, wherein each of the plurality of sensors is deployed at a corresponding location; and
one or more hardware processors in communication with the memory device and configured to:
determine a first sensor at a first location that has failed or is about to fail;
determine an effect to a merchant when the first sensor fails at the first location; and
provide information about the effect to the merchant on a merchant device.

2. The system of claim 1, wherein the sensor is a wireless beacon installed in a merchant location.

3. The system of claim 1, wherein the one or more processors are further configured to provide a suggested action to the merchant.

4. The system of claim 3, wherein the suggested action includes moving a second sensor from a second location to the first location.

5. The system of claim 1, wherein the first location is part of a plurality of locations of sensors at a merchant location.

6. The system of claim 1, wherein determining the first sensor is about to fail is based at least in part on a remaining battery power of the first sensor.

7. The system of claim 1, wherein determining the first sensor is about to fail is based on at least one of the first sensor's environmental condition, physical condition, or work loading.

8. The system of claim 1, wherein determining the effect is based at least in part on past transactions with the first sensor at the first location.

9. The system of claim 1, wherein determining the effect is based at least in part on current communication activity of the first sensor with consumer devices.

10. The system of claim 1, wherein the information about the effect comprises a decrease in transactions or in sales.

11. A method comprising:
determining, by a service provider, a first beacon at a first location that has failed or is about to fail;
determining, by the service provider, an effect to a merchant when the first beacon fails at the first location;
providing, by the service provider, information about the effect to the merchant on a merchant device; and
providing, by the service provider, a suggested action to the merchant.

12. The method of claim 11, wherein the suggested action includes moving a second beacon from a second location to the first location.

13. The method of claim 11, wherein the first location is part of a plurality of locations of beacons at a merchant location.

14. The method of claim 11, wherein the determining the first beacon is about to fail is based at least in part on a remaining battery power of the first beacon.

15. The method of claim 11, wherein the determining the first beacon is about to fail is based on at least one of the first beacon's environmental condition, physical condition, or work loading.

16. The method of claim 11, wherein the determining the effect is based at least in part on past transactions with beacons at the first location.

17. The method of claim 11, wherein the determining the effect is based at least in part on current communication activity of the first beacon with consumer devices.

18. The method of claim 11, wherein the information about the effect comprises a decrease in transactions or in sales.

19. A non-transitory computer-readable medium comprising instructions which, in response to execution by a computer system, cause the computer system to perform a method comprising:
determining a first beacon at a first location that has failed or is about to fail, wherein the first location is part of a plurality of locations of beacons at a merchant location;
determining an effect to a merchant when the first beacon fails at the first location;
providing information about the effect to the merchant on a merchant device; and
providing a suggested action to the merchant.

20. The non-transitory computer-readable medium of claim 19, wherein the determining the first beacon is about to fail is based on at least one of the first beacon's remaining battery power, environmental condition, physical condition, or work loading.
